(19) United States
(12) Patent Application Publication
(10) Pub. No.: US 2025/0299652 A1
(43) Pub. Date: Sep. 25, 2025

(54) Drumstick for Playing Musical Drums

(71) Applicant: Tecnoplast SRL, Romano D'Ezzelino (VI) (IT)

(72) Inventors: Alessandro Bordignon, Bassano Del Grappa (IT); Riccardo Bordignon, Cassola (IT)

(21) Appl. No.: 18/868,669

(22) PCT Filed: May 26, 2023
(86) PCT No.: PCT/IB2023/055421

§ 371 Date: Nov. 22, 2024

(30) Foreign Application Priority Data
May 27, 2022 (IT) 102022000011267

(51) Int. Cl. G10D 13/12; G10D 13/24

(52) U.S. Cl. CPC G10D 13/12; G10D 13/24

(57) ABSTRACT

A drumstick for playing drums includes a longitudinal gripping body of substantially circular cross-section, and a tip. The longitudinal gripping body is made of polyamide filled with carbon fibre.

### BACKGROUND OF THE DISCLOSURE

### 1. The Field of the Disclosure

The invention concerns a drumstick for playing musical drums.

### 2. The Relevant Technology

Drumsticks are an essential accessory for playing a percussion instrument consisting of skins and plates, such as drums, or the like.

Drumsticks may be of various sizes.

Traditionally, such drumsticks are made of wood, and different types of wood are known to be used depending on the style of music being performed.

The most commonly used materials include hardwoods such as:
hickory (American walnut): the most widely used and versatile;
oak: for those looking for particularly strong drumsticks;
maple: for those who like lighter drumsticks;
hornbeam: somewhere between hickory and maple.

Drumsticks made of synthetic materials, which provide even more resistance and maneuverability, are also becoming increasingly known and popular today.

In particular, among the most popular are drumsticks made of plastic with carbon additives, and drumsticks made of aluminium.

Innovative drumsticks based on carbon fibre are also known in the industry for their high balance and rigidity features.

These carbon fibre-based drumsticks are designed to have the same weight as wooden drumsticks, while allowing for better grip and handling than comparable wooden drumsticks.

Although well known and appreciated, these drumsticks have an aspect of perfectibility related to durability, as there is an increasing need in the industry for drummers to have drumsticks that do not break in a short period of time, where a generic average durability of a known type of drumstick can be estimated between one month and six months.

It is also desirable for drummers to have drumsticks that do not break for any reason during a performance, at the risk of ruining the musical performance itself.

### SUMMARY OF THE DISCLOSURE

The task of the present invention is to develop a drumstick for playing drums capable of obviating the aforementioned drawbacks and limitations of the prior art.

In particular, an aim of the invention is to develop a drumstick that is stronger and thus more durable than known types of drumsticks.

Another aim of the invention is to develop a drumstick that also has significant anti-vibrational qualities.

The task as well as the above-mentioned aims are achieved by a drumstick for playing drums according to the claims.

Further characteristics of the drumstick are described in the dependent claims.

### BRIEF DESCRIPTION OF THE DRAWINGS

The aforesaid task and objects, together with the advantages that will be mentioned hereinafter, are indicated by the description of an embodiment of the invention, which is given by way of non-limiting example with reference to the attached drawings, where:

FIG. 1 represents a side view of a drumstick according to the invention;

FIG. 2 represents a sectional view of the drumstick according to the invention.

### DETAILED DESCRIPTION OF THE PREFERRED EMBODIMENTS

With reference to the figures mentioned, a drumstick for playing drums according to the invention is indicated as a whole with the number 10.

This drumstick 10 comprises:
a longitudinal gripping body 11 with a substantially circular cross-section,
a tip 12.

The longitudinal gripping body 11 is made of polyamide filled with carbon fibre.

In particular, the polyamide is of the PA6.10 type, or another technically equivalent polyamide. Polyamide technically equivalent to polyamide PA6.10 is defined as a polyamide with a long polymer chain length of at least 10.

As far as this polyamide PA6.10 is concerned, it proved to be surprisingly suitable for use as a material for making a drumstick for playing drums, due to its mechanical capabilities of resistance to alternating bending that make it a material normally suitable for application fields such as robotics, pneumatics and industrial machinery in general.

In particular, polyamide PA6.10 is a long-chain polyamide that has two important improved characteristics over PA66 and even more so over PA6:
specific weight;
low moisture absorption.

The table below shows the relative comparison values of the polyamide PA6.10 used to make the drumstick 10 of the invention with polyamide PA66, and in particular the comparison between polyamide PA6.10 filled with carbon fibres [PA6.10 CF 30 (filled with 30% carbon fibre)], which is more similar to the material covered by the patent, with polyamide PA66 also filled with carbon fibres [PA66 CF 30 (filled with 30% carbon fibre)]:

| | | | | PA 6.10 | | PA 66 |
|---|---|---|---|---|---|---|
| | NORME | UNITA' | PA 6.10 | elastomerizzato/ | PA 66 | elastomerizzato/ |
| PROPRIETA' PROPERTIES | TEST | UNIT | CF 30 | with elastomer | CF 30 | with elastomer |
| Fisiche/Physical | | | | | | |
| Densitá/Specific Gravity | ISO 1183 | g/cm³ | 1.22 | 1.02 | 1.27 | 1.08 |
| Assorbimento d'acqua a 23° C. | ISO 62 | % | 0.8 | 1 | 1.9 | 2.3 |
| 50% U.R. | | | | | | |
| Water/Moisture Absorption at | | | | | | |
| 23° C. 50% R.B. | | | | | | |
| Assorbimento d'acqua a saturazione | ISO 62 | % | 1.8 | 2.4 | 6.5 | 7.2 |
| Water/Moistore Aborption of saturation | | | | | | |
| Modulo elastico a trazione | ISO 527 | MPa | 19200 d/ | 850 d/ | 22000 d/ | 1800 d/ |
| Tensile E-Modulus | | | 15800 c | 600 c | 14000 c | 700 c |
| Resistenza [symbol] Charpy con | ISO 179/1eA | kJ/m2 | 19 d/ | 90/ | 7 d/ | 80/ |
| intaglio, 23° C. | | | 19.5 c | 117 | 9 c | 110 |
| Charpy impact strength with a [symbol] , 13° C. | | | | | | |
| Termiche/Thermal | | | | | | |
| Punto di [symbol] /Melting Point | ISO 11357 | ° C. | 220-225 | 222 | 260 | 260 |

[symbol]

indicates data missing or illegible when filed

From this comparison, it is easy to note how:
the specific weight of PA6.10 is significantly lower than PA66 (PA6.10=1.22; PA66=1.27) which allows the production of a lighter and thus more manageable, precise and faster drumstick. These are all essential characteristics for a musical performance that is equal to and better than PA66 and PA6 drumsticks;
the low moisture absorption (PA6.10=0.8; PA66=1.9 and in saturation PA6.10=1.8; PA66=6.5) advantageously allows the PA6.10 drumstick to retain its initial mechanical properties over time much more than a PA66 drumstick, whose deterioration in rigidity performance and elastic modulus is evident once the drumstick has absorbed ambient moisture.

These two characteristics have an important effect on the handling performance and rigidity of the drumstick, and we can therefore state without any doubt, both from the data presented and from the numerous tests performed during the product development period, that it is not correct to consider PA6.10 equivalent to PA66 in general and especially in the specific application case.

Furthermore, the fact that the specific weight of PA6.10 is significantly lower makes it possible, on the one hand, to make drumsticks 10 which, for the same weight as the drumsticks of the known art, can be enriched with a higher percentage of carbon fibre or glass fibre, thereby making them significantly more rigid than drumsticks of the known art (e.g. made of PA66), or on the other hand, for the same percentage of carbon fibre or glass fibre included in the mixture, the drumsticks 10 of the invention made from PA6.10 have a lower weight than any drumsticks of the known art made from PA66.

In addition, tests carried out by the applicant have shown that the durability in the sense of fatigue resistance, i.e. repeated impact, of the drumstick 10 made of PA6.10 is very different from the durability of any drumstick made of PA66 (and PA6), since both physical tests on the materials and, above all, numerous use tests on the finished product have shown that PA6.10 is much better than PA66. In particular, the comparison of these tests shows that the drumsticks 10 made of PA6.10 compared to drumsticks made of PA66 have breakage lifetimes in the order of 3 to 4 times longer than the durability of PA66 drumsticks. See the graph below.

In particular, this comparative graph shows that the average lifetime of the drumsticks 10 according to the invention made of PA6.10 exceeds 100 hours of use, whereas the lifetime of PA66 drumsticks averages 30 hours, maximum 40 hours, and wood even stops at 10/20 hours of use.

A further value that helps to understand the difference between the two materials is the elongation at break according to ISO 527.

The dry elongation of the drumsticks 10 of the invention made of PA6.10 is almost double that of drumsticks made of PA66.

The next two graphs compare the elongation curves in a test performed directly on drumsticks made of the two different polymers in question, PA66 first and PA6.10 later, and having the same reinforcing fillers, i.e. carbon fibre and glass fibre. It is immediate to note that, even in the specific case of the product in question, the elongation of PA6.10 remains almost double that of PA66, confirming the better fatigue resistance performance that PA6.10 has over PA66. It is therefore incorrect to state that the two polymers have similar mechanical behaviour.

The drumstick 10 in PA6.10 has a maximum yield strength that is about 10% lower than the strength of the drumstick made of PA66; however, it has an elongation of around 24 mm whereas PA66 stops at 13, in fact almost double.

Returning to the preferred embodiment of the invention, this polyamide PA6.10 is filled with carbon fibre in a percentage between 5% and 35%.

Preferably, such polyamide PA6.10 is filled with carbon fibre in a percentage between 15% and 30%.

In particular, this polyamide PA6.10 is filled with 20% carbon fibre. In general, polyamide filled with carbon ensures rapid dissipation of frictional heat, bringing possible benefits for sliding applications as well.

Polyamide with 20% carbon fillers is the best balance between strength and toughness.

More specifically, polyamide PA6.10 has the characteristics of good wear and fatigue resistance, dimensional stability, and above all high resistance to fatigue, peculiarities that make the drumstick 10 more high-performance, durable and long-lasting than currently known drumsticks for playing drums.

Again, in particular, polyamide PA6.10 is filled with carbon fibre and glass fibre.

Preferably, but not exclusively, polyamide PA6.10 is filled with carbon fibre in a percentage between 5% and 30% and with glass fibre in a percentage between 30% and 50%.

For example, polyamide PA6.10 is filled with 5% carbon fibre and 41.55% glass fibre.

According to an embodiment of a drumstick 10 according to the invention, polyamide PA6.10 filled with carbon fibre and glass fibre is defined by the mixing of:
a first mixture comprising PA6.10 filled with 20% carbon fibre,
with a second PA6.10 mixture filled with 55% glass fibre.

In particular:
said first mixture is present in an amount between 15% and 35%,
said second mixture is present in an amount between 65% and 85%.

Preferably, but not exclusively, polyamide PA6.10 filled with carbon fibre and glass fibre is defined by the mixing of the first mixture present in an amount of 25%, and the second mixture present in an amount of 75%.

This mixture of the first mixture and the second mixture thus comprises polyamide PA6.10, which is filled as a whole with 5% carbon fibre and 41.5% glass fibre.

Still preferably, but not exclusively, polyamide PA6.10 filled with carbon fibre and glass fibre is defined by the mixing of the first mixture present in an amount of 33%, and the second mixture present in an amount of 67%.

This mixture of the first mixture and the second mixture thus comprises polyamide PA6.10, which is filled with 6.6% carbon fibre and 36.85% glass fibre.

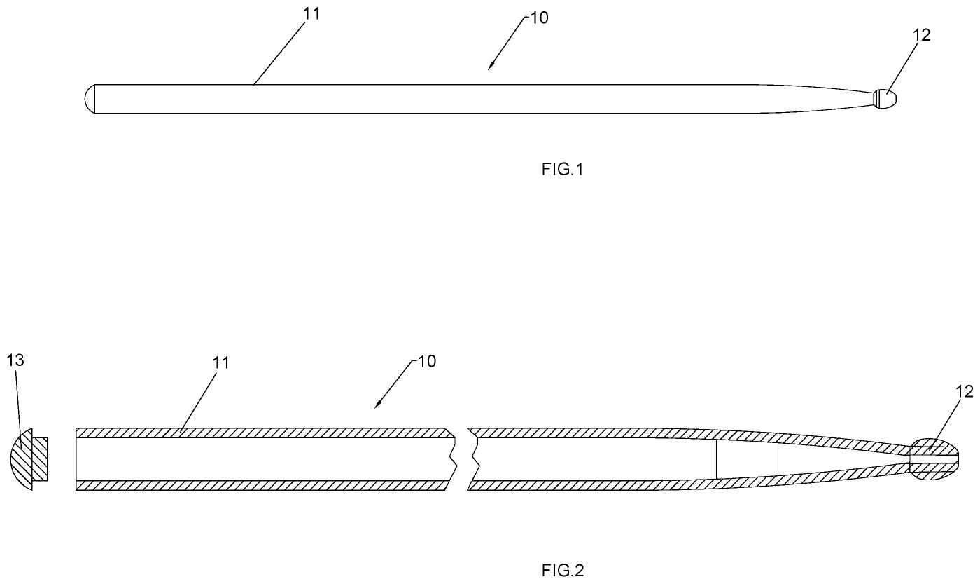

In the present embodiment, the longitudinal gripping body 11 progressively tapers at the portion adjacent to the top 12, as can be seen in FIG. 1.

Furthermore, in the present embodiment, the longitudinal gripping body 11 is tubular, as can be seen from the section in FIG. 2.

This peculiar structure allows the drumstick 10 to be manufactured in such a way that it has precise external dimensions and weight to suit the specific needs of users.

The tip 12 is made in a single piece with the longitudinal gripping body 11.

Accordingly, the longitudinal gripping body 11 and the tip 12 consist of a single body made of polyamide filled with carbon fibre as described above.

It is to be understood that the tip 12 may also be a rubber element overmoulded onto the longitudinal gripping body 11.

The drumstick 10 preferably also comprises an anti-vibration cap 13 configured to obstruct the end of the longitudinal gripping body 11 that is opposite the tip 12.

It has in practice been established that the invention achieves the intended task and objects.

In particular, the invention has developed a drumstick that is stronger and therefore more durable than known types of drumsticks.

In addition, the invention has developed a drumstick that also has important anti-vibrational qualities.

The invention thus conceived is susceptible of numerous modifications and variations, all of which are within the scope of the inventive concept; moreover, all the details may be replaced by other technically equivalent elements.

In practice, the components and materials, as long as they are compatible with the specific use, as well as the dimensions and the contingent shapes, can be any according to the requirements and the prior art.

If the characteristics and techniques mentioned in any claim are followed by reference signs, these reference signs are to be intended for the sole purpose of increasing the intelligibility of the claims and, consequently, such reference signs have no limiting effect on the interpretation of each element identified by way of example from these reference signs.

1. A drumstick for playing drums, comprising:
a longitudinal gripping body of substantially circular cross-section,
a tip,
wherein said longitudinal gripping body is made of PA6.10 type polyamide or another technically equivalent polyamide, filled with carbon fibre.

2. The drumstick according to claim 1, wherein said technically equivalent polyamide is polyamide with a long polymer chain length of at least 10.

3. The drumstick according to claim 1, wherein said polyamide PA6.10 is filled with carbon fibre in a percentage between 5% and 35%.

4. The drumstick according to claim 1, wherein said polyamide PA6.10 is filled with carbon fibre in a percentage between 15% and 30%.

5. The drumstick according to claim 1, wherein said polyamide PA6.10 is filled with 20% carbon fibre.

6. The drumstick according to claim 1, wherein said polyamide PA6.10 is filled with carbon fibre and glass fibre.

7. The drumstick according to claim 1, wherein said polyamide PA6.10 is filled with carbon fibre in a percentage between 5% and 30% and with glass fibre in a percentage between 30% and 50%.

8. The drumstick according to claim 1, wherein said polyamide PA6.10 is filled with 5% carbon fibre and 41.55% glass fibre.

9. The drumstick according to claim 1, wherein said polyamide PA6.10 filled with carbon fibre and glass fibre is defined by the mixing of:
a first mixture comprising PA6.10 filled with 20% carbon fibre,
with a second PA6.10 mixture filled with 55% glass fibre.

10. The drumstick according to claim 1, wherein:
said first mixture is present in an amount between 15% and 35%;
said second mixture is present in an amount between 65% and 85.

11. The drumstick according to claim 1, wherein said longitudinal gripping body is tubular.

12. The drumstick according to claim 1, wherein said drumstick is made as a single body with said longitudinal gripping body.

13. The drumstick according to claim 1, wherein said longitudinal gripping body progressively tapers at the portion adjacent to said tip.

14. A use of a drumstick according to claim 1 for playing drums.

15. A use of a drumstick according to claim 13 for playing drums.
